(19) United States
(12) Patent Application Publication
(10) Pub. No.: US 2006/0235863 A1
(43) Pub. Date: Oct. 19, 2006

(54) Enterprise computer management

(76) Inventor: Akmal Khan, Novato, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/106,859

(22) Filed: Apr. 14, 2005

(51) Int. Cl. G06F 17/00

(52) U.S. Cl. 707/101

(57) ABSTRACT

A management server has a file server containing operating systems and software packages utilized by typical computers in an enterprise. The management server also includes a bills of material module having bills of material that identify the roles of computers used by typical enterprises,, and one or more templates specifying the operating systems, software packages, and configuration files utilized by the computers in different roles. The management server can instantiate managed computers of a particular bill of materials using the templates, thereby creating computers functioning in the specified roles. The managed computers share the set of files on the file server. When a managed computer attempts to modify a shared file, the file server creates a new copy of the file, maps all requests from the managed computer to the new copy, and allows the modification to proceed. The management server tracks the changes.

### CROSS-REFERENCE TO RELATED APPLICATIONS

This application is related to, and incorporates by reference, the following U.S. patent application Ser. No. 10/413,440, filed Apr. 10, 2003, Ser. No. 10/841,808, filed May 7, 2004, Ser. No. 10/841,959, filed May 7, 2004, Ser. No. 10/877,753, filed Jun. 25, 2004, and Ser. No. 10/941,058, filed Sep. 13, 2004.

### BACKGROUND OF THE INVENTION

1. Field of the Invention

This invention pertains in general to managing computers on a network and in particular to centrally managing a set of computers utilized by an enterprise.

2. Background Art

Managing the information technology (IT) of a small technology company or other enterprise is a time consuming task. The enterprise might have 10-20 computers utilized by developers to write source code, a set of computers utilized by the marketing department to write documents, a data store, a web server, and a mail server. Each of these computers must be separately configured and maintained. At many technology companies the employees are technically-savvy and can manage their own computers. However, this management is time-consuming and the employees often end up wasting an inordinate amount of time maintaining their computers instead of working on their primary tasks.

One technique for simplifying management of the computers is to use the “boot from LAN” option (or the equivalent) to cause each computer to boot from a central server. The server maintains either a separate operating environment for each computer or a shared environment that is used by multiple machines. A problem with these techniques is that it is expensive to maintain separate copies of each computer's operating environment. Moreover, if several computers are booted from one environment, then any changes to the environment are made to all of the machines. Consequently, end-users cannot customize their computers without altering the other computers sharing the same operating environment.

Therefore, there is a need in the art for a way to manage multiple computers for an enterprise. Preferably, a solution to this need would use storage space efficiently and allow different computers to be configured separately.

### DISCLOSURE OF INVENTION

The above needs are met by providing a management server having a file server containing operating systems and software packages utilized by typical computers in an enterprise. The management server also includes a bills of material module having bills of material that identify the roles of computers used by typical enterprises, and one or more templates specifying the operating systems, software packages, and configuration files utilized by the computers in different roles. The management server can instantiate managed computers of a particular bill of materials using the templates, thereby creating computers functioning in the specified roles. The managed computers share the set of files on the file server. When a managed computer attempts to modify a shared file, the file server creates a new copy of the file, maps all requests from the managed computer to the new copy, and allows the modification to proceed. The management server tracks the changes and a backup of the enterprise's computers can be performed by backing up the mappings and the copied files.

### BRIEF DESCRIPTION OF THE DRAWINGS

FIG. 1 is a high-level block diagram illustrating an example of an enterprise having a management server connected to multiple managed computers via a network.

FIG. 2 is a high-level block diagram illustrating a functional view of a typical computer system for use as the management server and/or as a managed computer according to an embodiment of the present invention.

FIG. 3 is a high-level block diagram illustrating modules within the management server according to one embodiment.

FIG. 4 is a flowchart illustrating an example of the operation and use of the management server according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

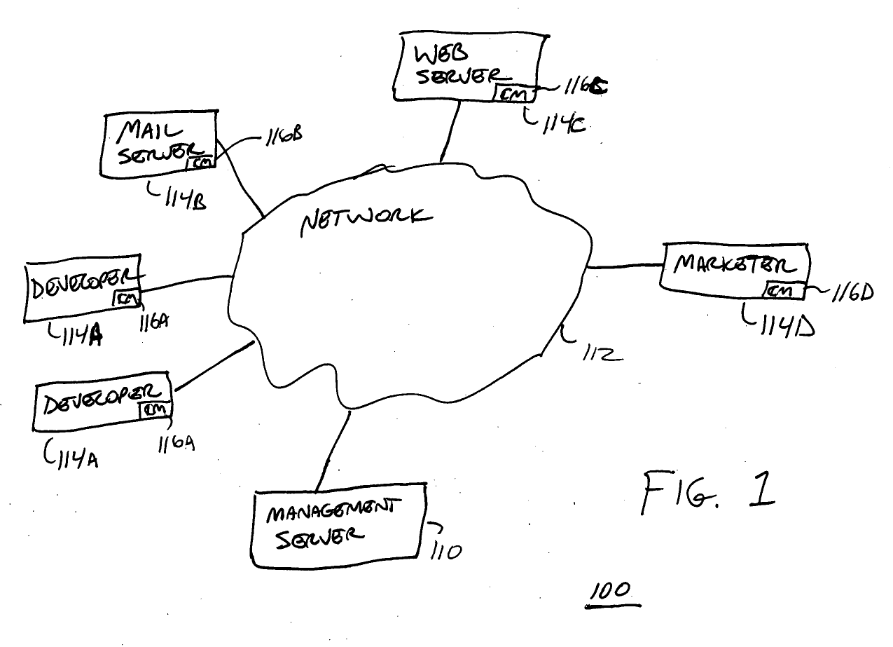

FIG. 1 is a high-level block diagram illustrating an example of an enterprise 100 having a management server 110 connected to multiple managed computers 114 via a network 112. FIG. 1 and the other figures use like reference numerals to identify like elements. A letter after a reference numeral, such as “114A,” indicates that the text refers specifically to the element having that particular reference numeral. A reference numeral in the text without a following letter, such as “114,” refers to any or all of the elements in the figures bearing that reference number.

In one embodiment, the enterprise 100 of FIG. 1 is an entity that has a need to control and configure multiple computers, but does not necessarily have an extensive staff dedicated to the task. Examples of typical enterprises include small- and medium-sized companies, educational concerns such as schools, Internet cafes, demonstration booths at trade shows, etc.

For example, the enterprise 100 of FIG. 1 is a small- or medium-sized company that has several different managed computers 114 serving in different roles. In FIG. 1, there are two instances of developer computers 114A. These computers 114A are utilized by developers to develop software programs for the enterprise. The developer computers 114A are configured to run a particular operating system and have software packages installed on them that permit software development and other functions required and/or desired by the developers. Another managed computer 114B is a mail server and likewise has a particular operating system and software packages on it that enable it to provide email messaging for the enterprise. Similarly, one managed computer 114C acts as a web server 114C and runs a web server program. An additional managed computer is a marketer computer 114 and executes an operating system and software packages that allow a marketing person for the company to design web pages, brochures, and the like.

Those of skill in the art will recognize that the managed computers 114 described above are just examples, and that in different embodiments the computers can have different roles and/or functionalities. For example, the developers 114A and marketers 114D can use computers with the same configuration, the mail server 114B and web server 114C can be combined onto one computer, and/or there can be another computer acting as a data store. Likewise, there can be one or more instances of any type of managed computer 114.

In other enterprises, the roles of the managed computers 114 are different. For example, a classroom in a school might have 20 instances of managed computers for use by students, and one instance of a managed computer for use by a teacher. The teacher's computer can have access to software packages that are not accessible to the student computers. Similarly, an Internet cafe might have 10 instances of managed computers having software packages for use by patrons and one instance of a managed computer to supervise billing for the patrons' computers. A demonstration booth at a trade show might have 10 instances of managed computers having the exact same configuration in order to demonstrate a software product.

In general, the role and functionality of each managed computer 114 is defined by the files it processes. The files provided during boot up establish the operating system the computer executes. The operating system can be, for example, LINUX or MICROSOFT WINDOWS XP, or a variant such as a WINDOWS instance emulated within LINUX. Other files accessible to the computer 114 establish the software packages that are available to be executed by the computer. The software packages can include, for example, application programs such an open source development environment for LINUX computers, MICROSOFT WORD for WINDOWS computers, etc. In addition, files within the operating system and/or software packages define the various parameters of the programs. These parameters control functionalities as varied as the desktop wallpaper displayed by the operating system, the login/password pairs that are valid for the computer, the preference settings of applications executing on the computer, etc.

In one embodiment, each managed computer 114 is configured to boot from files provided to it over the network 112 by the management server 110. Thus, when the computer is turned on or rebooted, it connects to the management server 110 and obtains the files that define its role. In one embodiment, each managed computer executes a control module 116 that facilitates communications between the managed computer 114 and the management server 110. However, other embodiments do not utilize the control module 116.

The management server 110 stores files that can be utilized to instantiate the computers required by a typical enterprise 100. An administrator at a specific enterprise can use the management server 110 to instantiate managed computers 114 in the roles required by that enterprise. In one embodiment, the management server 110 uses storage space efficiently by storing a single, shared copy of a file that is utilized by multiple managed computer instances. If a managed computer changes a shared file, such as when the computer is customized by an end-user, the management server 110 creates a new instance of the file and maps it to that managed instance. Change tracking and backups are simplified because changes to the managed computers 114 are captured by the set of changed files and mappings created by the management server.

The network 112 represents the communication pathways that allow the management server 110 and managed computers 114 to communicate. The network 112 can utilize dedicated and/or private communications links, and can also utilize shared links such as those that form the Internet. In one embodiment, the network 112 uses standard communications technologies and/or protocols such as Ethernet and the transmission control protocol/Internet protocol (TCP/IP). The data exchanged over the network 112 can be represented using technologies and/or formats including the hypertext markup language (HTML), the extensible markup language (XML), etc. Some or all of the links can be encrypted using conventional encryption technologies such as the secure sockets layer (SSL), Secure HTTP and/or virtual private networks (VPNs).

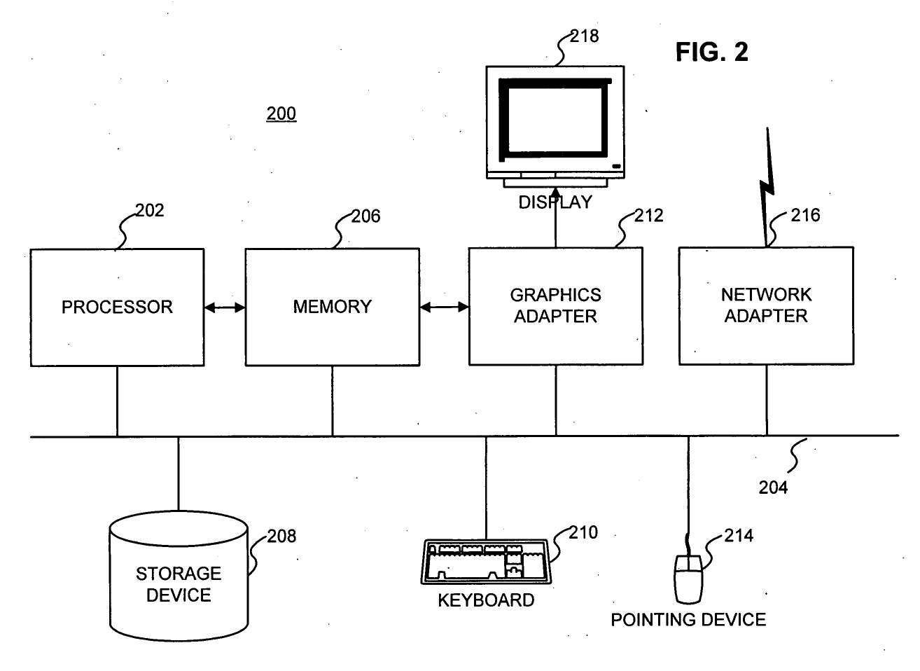

FIG. 2 is a high-level block diagram illustrating a functional view of a typical computer system 200 for use as the management server 110 and/or as a managed computer 114 according to an embodiment of the present invention. Illustrated are at least one processor 202 coupled to a bus 204. Also coupled to the bus 204 are a memory 206, a storage device 208 (which can be local and/or remote), a keyboard 210, a graphics adapter 212, a pointing device 214, and a network adapter 216. A display 218 is coupled to the graphics adapter 212.

The processor 202 may be any general-purpose processor such as an INTEL x86, SUN MICROSYSTEMS SPARC, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 108.

The computer system 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computer systems 200 utilized as the management server 110 and/or managed computer 114 can vary depending upon the embodiment and the processing power utilized by the entity. For example, a managed computer acting as a web server 114C may have more processing power than a computer utilized as a developer system 114A.

In one embodiment, the management server 110 is embodied in a single computer system appliance. The management server appliance includes at least one hard drive or other storage device 208 storing software for performing the functionality described herein. In one embodiment, the management server appliance includes hardware for enabling fault tolerance, such as a uninterruptible power supply (UPS) and/or multiple storage devices in a RAID configuration.

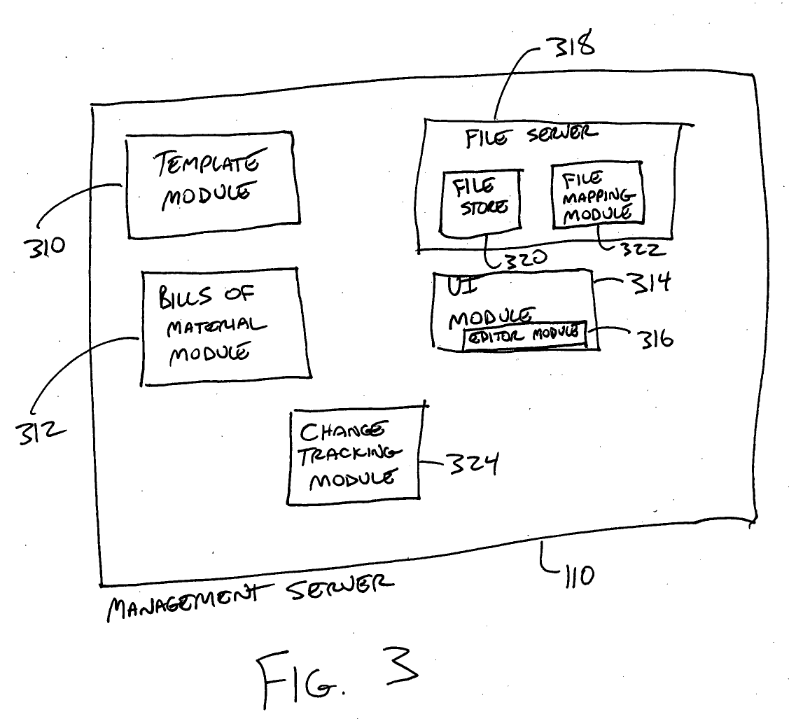

FIG. 3 is a high-level block diagram illustrating modules within the management server 110 according to one embodiment. Those of skill in the art will recognize that other embodiments can have different and/or other modules than the ones described here, and that the functionalities can be distributed among the modules in a different manner.

In one embodiment, the management server 110 includes a template module 310 for storing templates that can be applied to the managed computers 114. In general, a template is a description of an initial configuration of a managed computer 114. The template identifies the operating system for the managed computer, the software packages that are available on the computer, and the initial settings and/or parameters of the operating system and packages. In one embodiment, the template identifies the specific files on the management server 110 that are supplied to the managed computer 114 during boot up and execution. These files are identified through mappings that are discussed in more detail below. A template can also include meta-data describing the template itself. These data include, for example, the name of the template and the name of the managed computer created by the template.

Different templates are used to instantiate managed computers 114 in different roles. For example, a developer template is utilized to instantiate a developer computer 114A having the operating system, application programs, and settings utilized by the developers. Likewise, a mail server template is used to instantiate a managed computer 114 as a mail server 114B. Other embodiments of the templates module 310 have different and/or additional templates.

In one embodiment, the management server 110 also includes a bills of material module 312 identifying collections of templates that are utilized by typical enterprises 100. For example, a bill of material for a small company can identify the templates for managed computers 114 that are typically necessary and/or desired for a small company. As shown in FIG. 1, the templates within the small company bill of material can include a developer computer 114A, a mail server 114B, a web server 114C, a marketer computer 114D, etc. In another example, a bill of material intended for a classroom or other educational facility can include student computers having a relatively limited set of applications and permissions, and a teacher computer having a broader range of application and permissions. Other embodiments of the bills of material module 312 have other collections of templates.

An embodiment of the management server 110 includes a user interface (UI) module 314 that presents a UI with which the administrator can control the management server. Through the UI, the administrator can identify managed computers 114 on the network 112 and select a bill of material and/or templates to apply to the computers. In one embodiment the UI module 314 presents a web browsing interface, such as hypertext markup language (HTML) web pages, that the administrator can access using a conventional web browser. Other embodiments provide other types of UIs.

In one embodiment, the UI module 314 includes an editor module 316 that the administrator can use to create, modify, and delete templates and/or bills of material for managed computers 114. In one embodiment, the editor module 316 provides functionality allowing an administrator to load a base template or bill, modify it, and save it as new. The modifications can include high-level changes such as changing the operating system and/or software packages available on the managed computer 114, and/or low-level changes such as changing a particular configuration file utilized by the managed computer. In one embodiment, the editor module 316 provides functionality allowing an administrator to take a “snapshot” of an existing managed computer 114 and then make a template having the characteristics of that computer. This latter embodiment is useful because it allows an administrator to make configuration changes to a managed computer 114 and then memorialize the changes as a template.

A file server module 318 serves files to the managed computers 114 and controls the files that are “visible” or otherwise available to each managed computer. A file store module 320 stores the files that are provided by the file server 318 to the managed computers 114. The file store module 320 stores operating systems, software packages, and/or other collections of files that can be utilized by the managed computers 114. For example, in one embodiment the file store module 320 includes one or more LINUX distributions and one or more software packages that execute on the distributions. The software packages can include server software for implementing a web server, a DNS server, a mail server, etc. Likewise, the software packages can include application programs such as word processors, program editors, debuggers, and

Typically, Linux packages are distributed in a compressed state. Accordingly, an embodiment of the file store 320 uses “lazy unpacking.” The packages are initially stored by file store 320 in the compressed state, but are decompressed (i.e., expanded) into the normal executable state when the packages are first added to a managed computer instance. As a result, the files forming the packages that are utilized by at least one managed computer 114 are stored in the file store 320 in an immediately-executable state. These storage techniques allow a relatively large number of packages to be stored in the file store 320.

A file mapping module 322 performs transparent file mapping for the managed computers 114. In one embodiment, the file mapping module 322 stores data implementing a table describing file mappings for the managed computers 114. The file mappings can selectively map a managed computer's request to access a file, directory, and/or volume to a different file, directory, and/or volume in the file store 320. For example, the table can implement the following relationships:

| Managed Computer | File | Remap |
|---|---|---|
| 1 | /lib/libc.so.6 | /mmt/glibc-14/lib/libc.so.6 |
| 2 | /lib/libc.so.6 | /mmt/glibc-14/lib/libc.so.6 |
| 3 | /lib/libc.so.6 | /mmt/glibc-15/lib/libc.so.6 |

This table indicates that the file mapping module 322 maps requests by managed computers 1 and 2 for “/lib/libc.so.6” to the directory containing version 14 of the requested file. In contrast, the file mapping module 322 maps requests by managed instance 3 for “/lib/libc.so.6” to a directory containing version 15 of the requested file. Thus, the file mapping module 322 allows the file server 318 to provide different managed computers 114 with different files, even when the managed computers “think” that they are accessing the same file. Such remapping effectively allows different managed computers 114 to execute different versions of software packages and/or data files even though the configurations of the managed instances are otherwise identical. In one embodiment, the mappings are performed based on keys other than the managed computer. For example, one embodiment performs mappings based on the end-user of the computer.

In one embodiment, the file mapping module 322 initially provides minimal mapping, so that different instances of managed computers in the same role use the same file wherever possible. This technique minimizes storage requirements for the file store 320 because it allows multiple managed computers 114 to share a single version of an operating system and/or software package.

When a managed computer 114 writes to a shared file, the file mapping module 322 traps the write request, creates a copy of the file in the file store 320, establishes a mapping for the managed computer to the copy of the file, and executes the write request on the copy. The mapping effectively causes any subsequent requests for the file by the managed computer 114 to be transparently mapped to the modified copy. In one embodiment the mappings are persistently maintained and are always applied to the particular instance of the managed computer 114. Each managed computer 114 thus uses a shared set of files that it has not changed, and its own set of modified files.

In use, the file mapping module 322 allows each end-user of a managed computer 114 to customize the computer to his liking. For example, an administrator can create an instance of a developer managed computer 114A from a template. The developer who uses the computer can then customize the machine. The customizations are recorded as changes to files used by the managed computer. The file mapping module 322 creates a set of file copies and mappings that record these changes.

The management server 110 includes a change tracking module 324 that tracks changes to files made by the managed computers 114. In one embodiment, the change tracking module 324 monitors the operation of the file mapping module 322 and identifies any files and/or mappings created at given points in time. The change tracking module 324 can be used to perform maintenance such as file backups. For example, the enterprise can maintain a backup copy of the shared files and perform incremental backups of the entire enterprise's configuration by storing only the changed files and mappings. Moreover, the change tracking module 324 can be used to rollback (i.e., reverse) changes to one or all of the managed computers 114 by causing the managed computers to revert to the shared files and/or earlier copies and mappings.

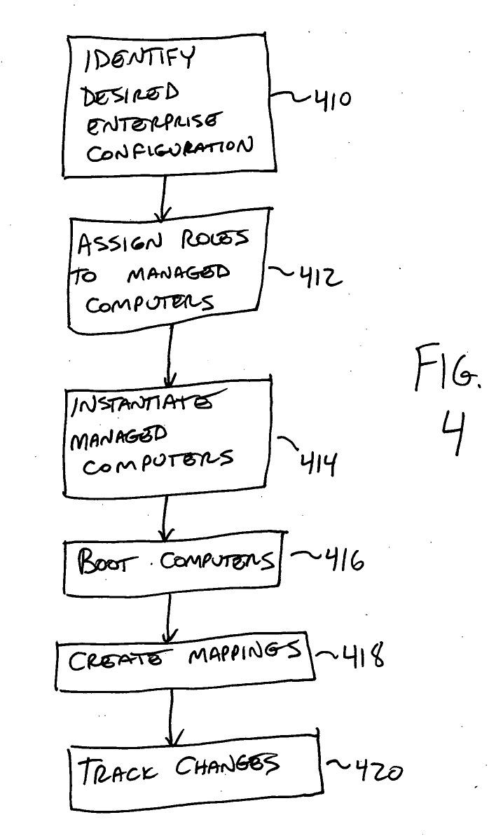

FIG. 4 is a flowchart illustrating an example of the operation and use of the management server 110 according to one embodiment. Those of skill in the art will recognize that other embodiments can perform the steps of FIG. 4 in different orders. Moreover, other embodiments can include different and/or additional steps than the ones described here.

Assume for purposes of this example that a small enterprise has a need for a set of computers, including developer computers, marketing computers, a web server, and a mail server. Therefore, an administrator at the enterprise obtains a management server 110 and one or more conventional personal computers suitable for use as managed computers 114. The administrator couples the management server 110 and the managed computers 114 to a network 112 and configures the managed computers to boot from the management server 110.

The administrator uses the UI provided by the management server 110 to identify 410 a desired configuration for the enterprise's computers. In one embodiment, the administrator performs this task by selecting a bill of materials on the management server 110 that identifies the roles of managed computers 114 typically utilized by a small enterprise, such as developer computers, a web server, etc. The administrator uses the UI to assign 412 roles to each of the managed computers 114.

In response, the management server 110 uses the templates to instantiate 414 managed computers 114 in each of the assigned roles. For example, if the administrator has assigned a managed computer the role of a web server, the management server 110 establishes the software mappings in the file server 318 that are specified by the web server template. When the managed computer 114 is booted 416, the management server 110 provides it with the files identified by the web server template, which causes the managed computer to act as a web server.

When the managed computer 114 attempts to modify a file in the file server module 318, the file server module 318 copies the file, creates 418 a mapping to the copied file for the managed computer, and allows the managed computer to modify the copied file. The mapping is persistent, so that next time the managed computer 114 accesses the same file it will access the mapped-to copy.

The management server 110 tracks the changes made by the managed computers 114. Primarily, the changes are the new files made in response to file modifications by the managed computers 114, and the mappings that point to the new files. These tracked changes can be used to make incremental backups of the management server 110 and, by extension, of the entire enterprise computing environment.

In sum, the management server 110, which can be packaged as an appliance, allows an enterprise to configure managed computers 114 to meet the needs of the enterprise. In one embodiment, the management server 110 includes templates and software that allow instances of the managed computers 114 to be created for specific roles. Moreover, the management server 100 includes bills of material that identify the templates that are typically utilized by particular enterprises. End-users of the managed computers 114 can customize the computers, and the management server 110 captures the results of the changes as modified files and mappings.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

I claim:

1. A system for managing computers for an enterprise, comprising:
a file store module adapted to store files utilized by managed computers;
a mapping module adapted to map requests for files received from the managed computers to particular files stored by the file store module;
and
a template module adapted to store a template describing a managed computer having a role, the description identifying files on the file store and mappings in the mapping module for instantiating a managed computer in the role.

2. The system of claim 1, wherein the file store module stores a shared set of files that are utilized by multiple managed computers and a private set of files that are utilized by only a particular managed computer.

3. The system of claim 1, wherein the file store module stores a shared set of files that are utilized by multiple managed computers and wherein the mapping module is adapted to transparently intercept a request from a managed computer to modify a file in the shared set and direct the request to a private version of the file associated with only the managed computer.

4. The system of claim 1, wherein the file store module stores a shared set of files that are utilized by multiple managed computers and a private set of files that are utilized by only one managed computer and wherein the mapping module transparently maps a request from the managed computer for a file in the shared set to a file in the private set.

5. The system of claim 1, wherein the template module is adapted to store a plurality of templates for instantiating managed computers in a plurality of different roles.

6. The system of claim 1, wherein the template module is adapted to store a plurality of templates for instantiating managed computers in a plurality of different roles and further comprising:
a bills of material module adapted to hold bills of material, each bill of material identifying one or more templates for instantiating managed computers in roles likely to be used by a specific type of enterprise.

7. The system of claim 1, further comprising:
a change tracking module for identifying changes to instantiated managed computers at the enterprise.

8. A computer program product having a computer-readable medium having computer program instructions embodied therein for managing computers for an enterprise, the computer program instructions comprising:
a file store module adapted to store files utilized by managed computers;
a mapping module adapted to map requests for files received from the managed computers to particular files stored by the file store module; and
a template module adapted to store a template describing a managed computer having a role, the description identifying files on the file store and mappings in the mapping module for instantiating a managed computer in the role.

9. The computer program product of claim 8, wherein the file store module stores a shared set of files that are utilized by multiple managed computers and a private set of files that are utilized by only one managed computer.

10. The computer program product of claim 8, wherein the file store module stores a shared set of files that are utilized by multiple managed computers and wherein the mapping module is adapted to transparently intercept a request from a managed computer to modify a file in the shared set and direct the request to a private version of the file associated with only the managed computer.

11. The computer program product of claim 8, wherein the file store module stores a shared set of files that are utilized by multiple managed computers and a private set of files that are utilized by only one managed computer and wherein the mapping module transparently maps a request from the managed computer for a file in the shared set to a file in the private set.

12. The computer program product of claim 8, wherein the template module is adapted to store a plurality of templates for instantiating managed computers in a plurality of different roles.

13. The computer program product of claim 8, wherein the template module is adapted to store a plurality of templates for instantiating managed computers in a plurality of different roles and further comprising:
a bills of material module adapted to hold bills of material, each bill of material identifying one or more templates for instantiating managed computers in roles likely to be used by a specific type of enterprise.

14. The computer program product of claim 8, further comprising:
a change tracking module for identifying changes to instantiated managed computers at the enterprise.

15. A method of managing computers for an enterprise, comprising:
providing a file store storing files utilized by managed computers;
instantiating a managed computer in a role described by a template; and
creating file mappings responsive to the template, the file mappings mapping requests for files received from the managed computer to particular files stored by the file store module that are associated with the role.

16. The method of claim 15, wherein the file store stores a shared set of files that are utilized by multiple managed computers and a private set of files that are utilized by only one managed computer.

17. The method of claim 15, wherein the file store module stores a shared set of files that are utilized by multiple managed computers, further comprising:
intercepting a request from the managed computer to modify a file in the shared set; and
directing the request to a private version of the file associated with only the managed computer.

18. The method of claim 15, wherein the file store stores a shared set of files that are utilized by multiple managed computers and a private set of files that are utilized by only one managed computer, further comprising:
mapping a request from the managed computer for a file in the shared set to a file in the private set.

19. The method of claim 15, further comprising:
identifying changes to instantiated managed computers at the enterprise.

20. The method of claim 19, wherein identifying changes comprises:
identifying sets of files on the file store each associated with a managed computer; and
identifying sets of file mappings mapping requests for files from each managed computer to the set of files on the file store associated with the managed computer.
